(19) United States
(12) Patent Application Publication
(10) Pub. No.: US 2005/0000135 A1
(43) Pub. Date: Jan. 6, 2005

(54) Printable identification tag

(76) Inventor: Constance C. Trigger, Niskayuna, NY (US)

Correspondence Address: Charles B. Lobsenz;Roberts Mlotkowski & Hobbes, Suite 850, 8270 Greensboro Dr., McLean, VA, 22102-3835, US

(21) Appl. No.: 10/765,771

(22) Filed: Jan. 27, 2004

Related U.S. Application Data
(60) Provisional application No. 60/483,946, filed on Jul. 1, 2003.

(51) Int. Cl. G09F 3/14

(52) U.S. Cl. 40/664

(57) ABSTRACT

The present invention comprises an identification tag which may be secured to a variety of objects to identify such objects and to distinguish such objects from one another. The tag of the present invention comprises a label portion on which a name and other identification information is placed. An attachment portion is attached to the label portion via a small hole punched on the outer periphery of the label portion. In a preferred embodiment, the label portion is formed from pre-cut heat shrinkable plastic which may be formed into an unlimited number of shapes and sizes. The attachment portion, which is attached to the label portion is easily attached to a great many objects via an easy looping procedure.

### CROSS-REFERENCE TO RELATED APPLICATION

This application claims priority of U.S. Provisional Application No. 60/483,946 filed Jul. 1, 2003, the disclosure of which is incorporated fully herein.

### BACKGROUND

1. Field of the Invention

The present invention relates generally to tags and labels and more particularly to a tag assembly which is easily manufactured and capable of a wide variety of identification applications.

2. Background of the Invention

There are a wide variety of instances in which it is desirable to label an object for identification. In response to this need, there are a great many tags and related items geared to providing such identification. It is often important to identify or otherwise label objects in the case wherein such objects are either exactly the same or otherwise subject to misidentification as a result of being visually closely similar. For example, in the case of luggage arriving on a conveyor belt at an airport, it is often pointed out that many bags are the same or at least look similar and the possibility of someone retrieving and leaving with the wrong bag is quite real. In this case, either or both of an airline applied tag with an identification number and/or a luggage tag specifying the owner's name, address, etc. should be checked to determine whether or not the right bag has been identified.

Another example of a situation wherein it is extremely desirable to identify similar objects by owner through tagging arises in connection with swimming activities and in particular, with respect to swim goggles. Swimmers attending swim meets, swim classes and other related group based swimming activities are at risk of not leaving with the swim goggles that they arrived with. This is due in large part to the great number of goggles present and the fact that many swim goggles used are either exactly the same or at least extremely similar in appearance. Further, swim goggles can be lost or misplaced either at a swimming event or elsewhere. In this case it is beneficial for the goggles to be tagged with contact information so that the owner can be contacted to retrieve his or her goggles.

An almost unlimited number of similar situations arise wherein it is desirable to tag and identify objects to avoid confusion or to recover lost items or for other reasons. While various tags exist, in many cases they suffer from a number of drawbacks which are either general drawbacks or drawbacks which arise only with respect to particular applications. For example, in many cases including the swim goggle example above, it is desirable for the tag to be waterproof so that when the tag is immersed in water it is not destroyed and does not lose the identification information. Various other tagging applications exist for an almost infinite variety of items including, for example other sporting equipment and/or other applications in which a waterproof tag is desirable. Other existing tags suffer from various other drawbacks including expensive and/or time consuming manufacturing requirements, improper or undesirable sizes, difficulty or inappropriate means for attaching the tag to or detaching the tag from the object to be tagged and other less than desirable characteristics.

### SUMMARY OF THE INVENTION

It is therefore a primary object of the present invention to provide an identification label or tag which is designed to overcome the above stated problems, drawbacks and deficiencies.

It is another object of the present invention to provide an identification tag which is easy to manufacture and which may be manufactured at a low cost.

It is yet another object of the present invention to provide an identification tag which may be used in a wide variety of labeling applications.

It is a still further object of the present invention to provide an identification tag which is waterproof.

It is an even further object of the present invention to provide an identification tag which is easily attached to and unattached from an object which is to be labeled.

It is still another object of the present invention to provide an identification tag which is attractive looking and which may be easily manufactured in a variety of shapes, sizes and colors.

These and other objects of the present invention are obtained in connection with a novel identification tag as described herein. The identification tag is easily manufactured in a variety of shapes and sizes and it is waterproof. Further, the identification tag of the present invention is easily attached to an almost unlimited number of objects via a fast and easy attachment methodology.

According to a preferred embodiment of the invention, the identification tag of the present invention comprises a label portion on which a name and other identification information is placed. An attachment portion is attached to the label portion via a small hole punched on the outer periphery of the label portion. In a preferred embodiment, the label portion is formed from pre-cut heat shrinkable plastic which may be formed into an unlimited number of shapes and sizes. The attachment portion, which is attached to the label portion is easily attached to a great many objects via an easy looping procedure which is outlined in detail below.

These and other advantages and features of the present invention are described herein with specificity so as to make the present invention understandable to one of ordinary skill in the art.

### BRIEF DESCRIPTION OF THE DRAWINGS

FIG. 1 is a plan view of an identification tag including a label portion and a attachment portion according to a preferred embodiment thereof;

FIG. 2 is an illustration of the identification tag of FIG. 1 as attached to the strap of an object to be identified in one preferred embodiment of the present invention; and

FIG. 3 is a flowchart illustrating the steps, in a preferred embodiment for making the identification tag of the present invention.

### DETAILED DESCRIPTION OF THE INVENTION

The present invention is now discussed to provide the reader with a detailed description of the novel printable identification tag of the present invention. It will be understood that while the following discussion addresses particular embodiments and applications of the present invention, the claimed invention is not necessarily limited thereto and other embodiments and applications exist and the present invention is limited only by the specific claims appended hereto.

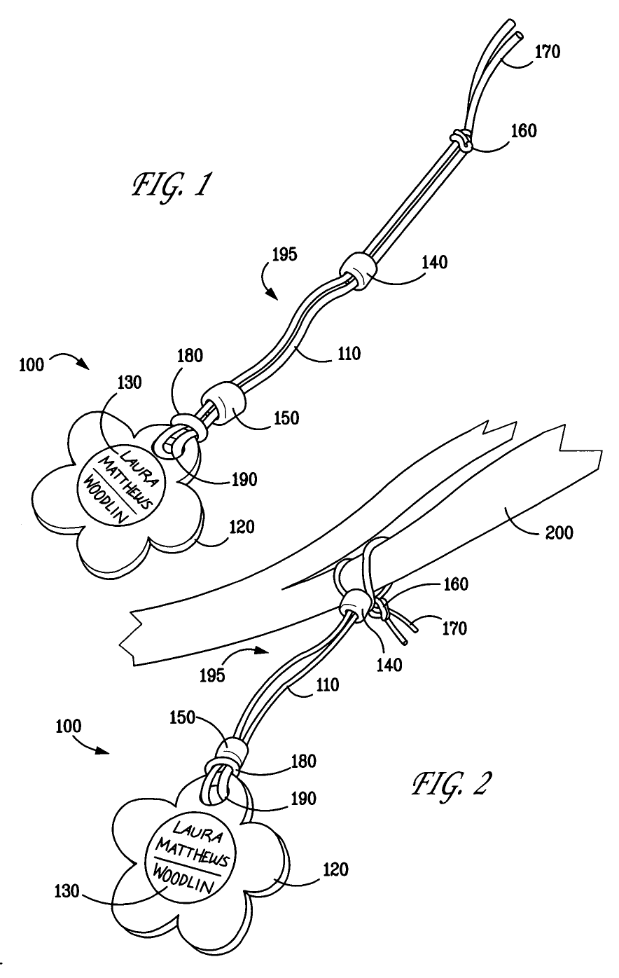

Referring now to FIG. 1, the printable identification tag (ID Tag) 100 of the present invention is shown in a preferred embodiment thereof. ID Tag 100 is comprised of two primary components, an attachment portion 195 and a label portion 120. Label portion 120 is secured to attachment portion 195 as a result of cord 110 which forms attachment portion 195 being looped through a hole 190 in label portion 120 and back through itself. Label portion 120 may be one of an almost unlimited number of shapes and/or sizes but is preferably sized and shaped to make manufacturing as easy and inexpensive as possible and as described below. Hole 190 is preferably located somewhere on the periphery of label portion 120 such as, for example 1/8 inch from the edge of label portion 120.

Label portion 120 preferably includes an identification marking portion 130 contained therein. Identification marking portion 130 is preferably located somewhere near the center of label portion for aesthetic reasons although such a location is not necessarily required. Identification marking portion 130 may be of any shape and size so long as it fits within the confines of label portion 120. Various identification information may be presented on identification marking portion 130 such as, for example, name, address, phone number, product type, bar code information, SKU number, affiliation, company, age of product, etc. Various other data which may or may not be reflective of characteristics of the tagged object may alternatively be presented in the identification marking portion 130 or elsewhere on label portion 120. By way of example only, in the case of a tag designed for use in connection with swim goggles (or some other sports related equipment), data may also include team name, school name and other applicable information.

Cord 110 may be formed from any flexible material but it is preferably waterproof, stretchy, easily tied and durable. For example, cord 110 may be formed from 0.7 mm-1 mm diameter polymer material or jewelry cord or a similar material. In one embodiment of the present invention, cord 110 is formed from a clear, flexible polymer although various other materials and color choices may be selected without departing from the scope or spirit of the present invention.

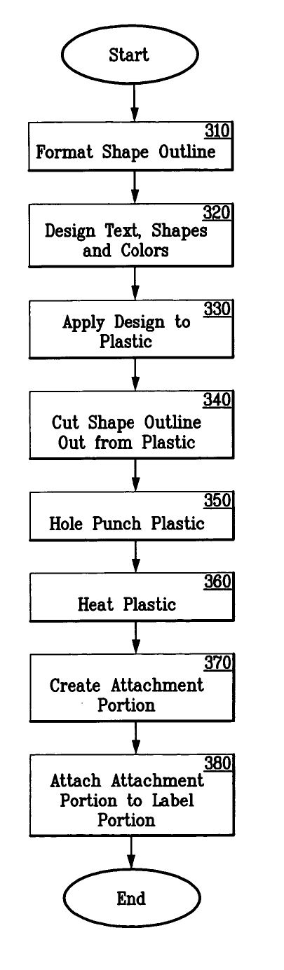

As will be discussed in further detail below, attachment portion 195 preferably contains two beads through which cord 110 is threaded through. A first bead 140 is slidably located on the flexible cord 110 between label portion 120 and the other end of attachment portion 195. Bead 140 is included in order to hold the loop created by flexible cord 110 tight in the vicinity of the object to be tagged. When tag 100 is attached to, for example, swim goggles, the end of flexible cord which is distant from label portion 120 is wrapped around, for example, the goggle strap and label portion 120 is then passed through the formed loop so as to attach tag 100 to the swim goggles as shown best in FIG. 2. Bead 140 is slid against the formed loop at the swim goggle strap to hold the formed loop tight against the swim goggle strap.

A second bead 150 is optional and may be placed at the end of attachment portion 195 which is in closest proximity to label portion 120. This bead 150 is used to hold the through loop 180 created by threading attachment portion 195 through hole 190 in place. Beads 140 and 150 may, in a preferred embodiment, be an “E” size glass rochaille bead typically used in connection with various jewelry applications. Beads 140 and 150 are sized such that they may be moved along the flexible cord 110 comprising attachment portion 195 with some degree of force but beads 140 and 150 should not have a center bore which is so large that beads 140 and 150 move too freely along the flexible cord 110 without exertion of some force.

In a preferred embodiment of the present invention, the flexible cord 110 forming attachment portion 195 is folded over upon itself as shown in FIG. 1 and a knot 160 is placed in the end distal to label portion 120. Knot 160 is preferably formed to lead a tail 170 at the end of attachment portion 195. Of course many other embodiments for securing flexible cord 110 to label portion 120 are possible. For example, flexible cord 110 can be formed as a continuous loop, fed through hole 190 and then passed through itself to create loop 180. In this case knot 160 and tail 170 would not be present.

Now that the overall structure of the identification tag 100 of the present invention has been described in connection with a preferred embodiment thereof, a discussion of one possible way in which to manufacture the novel device is next provided in connection with FIG. 3.

Using a computer graphics program, hand formatting or other means, the desired tag shape is formatted as a simple line drawing at step 310. Examples of shapes which may be used to form label portion 120 include a fish, a flower, an oval, a rectangle, a heart or a star. Alternatively, an infinite number of shapes may be used including, by way of example only, the shape of label portion 120 as illustrated in FIG. 1.

For purposes of illustration only, and in one embodiment of the present invention, approximate shape sizes (prior to shrinking) for label portion 120 may be as follows:

| | |
|---|---|
| Fish - | 1½ inches × 2⅞ inches |
| Flower - | 2¾ inches × 2¾ inches |
| Oval - | 2 inches × 2½ inches |
| Rectangle - | 1½ inches × 2⅞ inches |
| Heart - | 2½ inches × 2½ inches |
| Star - | 2¾ inches × 2¾ inches |

It will be readily understood that so long as label portion 120 is appropriate for the application, practically any size or shape can be used.

In addition to the overall shape of label portion 120, at step 320 other aspects of label portion 120 are designed and laid out in a manner that is esthetically pleasing. This includes the text or other information which appears on label portion 120 within identification portion 130 if present as well as the particular colors and their boundaries within label portion 120. Text may consist of for example, one, two or three lines of letters, numbers and/or symbols reflecting personalized or other information applicable to the owner, the object being labeled or something else. The shapes, text and coloring for label portion 120 are preferably laid out and generated using a computer software application such as, for example, Microsoft Word or a graphics program such as Broderbund Printmaster or Adobe Photoshop or any other program permitting the design of label portion 120.

In a preferred embodiment of the present invention, label portion 120 and identification portion 130, if present, should be created such that identification portion 130 is in color contrast with the surrounding portion of label portion 120. In other words, in a typical construction, label portion 120 forms the surrounding area around identification portion 130. As mentioned above, identification portion 130 preferably contains a textbox with the text or other information therein. By way of example, label portion 120 may be pink in color in the areas outside of identification portion 130 while identification portion 130 itself is clear or slightly opaque in color. The text applied to identification portion 130 may be, for example, black.

It is also possible to create label portion 120 to consist of only a shape with text (or some other indicia) thereon, i.e. without a separate identification portion. For example, label portion 120 may be created to be completely clear or opaque throughout with text placed anywhere on label portion 120 as opposed to within a specific interior box within label portion 120.

Various shapes, sizes and colors may be used for both label portion 120 and identification portion 130 and the text. For example, oval shaped identification portions 130 may be inserted into the fish and oval shaped label portions 120. A circle shaped identification portion 130 is preferably inserted into a flower shaped label portion 120 (as shown in FIG. 1). A smaller rectangular shaped identification portion 130 is preferably inserted into one end of a rectangular shaped label portion 120. A matching but smaller heart shaped identification portion is preferably inserted into a heart shaped label portion 120 and likewise, a matching but smaller star shaped identification portion 130 is preferably inserted into a star shaped label portion 120. Of course these and other arrangements, sizing and shaping of the label portion 120, the identification portion 130 and their relationship with respect to one another may be used without departing from the scope or spirit of the present invention.

The information recorded in the text area of the identification portion 130 (or on label portion 120 itself, if no separate identification portion area 130 is used) may include, in the case of a tag intended to be attached to swim goggles, a person's first name, last name, school, pool or swim team name, phone number, etc. Identification portion 130 with the personalized information described above should be created such that the size of the text is adjusted and formatted to fit within the boundaries of identification portion 130.

Next, in one embodiment of the present invention, at step 330 the formatted label portion 120 created as a result of the design steps 310 and 320 are printed onto a sheet of heat shrinkable plastic. In other words, following the design of the label portion 120 (including the overall shape and the overall color of the label portion 120 and the shape and color of the identification portion 130 if present and the text) the overall design is applied to the plastic sheet. This is preferably accomplished by using the print function of the software application with a sheet of heat shrinkable plastic in the printer. Alternatively, the shapes, colors and text contained in label portion 120 and identification portion 130 if present may be drawn by hand on the heat shrinkable plastic.

In a preferred embodiment, the heat shrinkable plastic is a sheet of plastic material which increases in thickness and decreases in height and width by approximately 30% when heated. Heat shrinkable plastic as may be used in connection with the manufacture of the label portion 120 of the present invention is available from many sources including “Frosted Rough and Ready” heat shrinkable plastic sold by K&B Innovations in North Lake, Wis. and a shrinkable film product available through Graphix Company in Cleveland, Ohio.

The ink used to print the text and the design of label portion 120 should be waterproof ink. Preferably, a standard printer designed as a peripheral for a personal computer may be used for printing the text. “Draft” or “Fast” quality printer settings should be chosen as “Normal” or “Best” settings may result in smearing. In one embodiment, the text and shapes forming the various sections of label portion 120 are printed on the sheet of heat shrinkable plastic preferably with a color printer. For sections having color, a “fill pattern” is used.

Once the shapes have been outlined and the design information has been applied to the heat shrinkable plastic, the next step (step 340) is to cut the shapes from the sheet of heat shrinkable plastic material. The shapes should be cut from the heat shrinkable plastic using scissors, a craft knife, extra large paper punches, die-cut equipment or other cutting equipment. Using a 1/4 inch hole punch or similar tool, hole 190 may be punched (step 350) into the tag shape on the heat shrinkable plastic sheet so as to accommodate cord 110 passing therethrough.

The next step (step 360) is to reduce label portion 120 to the desired size. Label portion 120 is reduced to its final size through baking in an oven on a piece of heavy paper or brown bag paper which is placed on a baking sheet in an oven set to somewhere around 325° F. for approximately 30 seconds or as otherwise indicated in the heat shrinkable plastic manufacturer's instructions.

Based on this, the approximate final sizes of label portion 120 in connection with various exemplary selected sizes and shapes are listed below. The thickness of all the shapes is preferably approximately 1/16 inch.

| | |
|---|---|
| Fish - | ⅝ inch × 1⅛ inches |
| Flower - | 1⅛ inches × 1⅛ inches |
| Oval - | 1⅛ inches × ⅞ inches |
| Rectangle - | ½ inch × 1¼ inches |
| Heart - | 1 inch × 1 inch |
| Star - | 1 inch × 1 inch |

The next step is to create the cord and bead assembly associated with attachment portion 195 (step 370) and attach it to label portion 120 (step 380). Tag 100 of the present invention may be attached to, for example, swim goggles via a 0.7 mm-1 mm diameter, stretchy polymer jewelry cord that is threaded through at least one “E” size glass rochaille bead. Other cords 110 with similar properties may also be used so long as they can fit through hole 190.

To create attachment portion 195, as shown in FIGS. 1 and 2, and in a preferred embodiment, a 7 inch length of cord is folded in half. An “E” sized glass rochaille bead 140 is threaded over the cut ends of cord 110 onto the doubled cord. A bead threader formed as a very thin and flexible piece of wire may be used to thread the beads over the folded end of the doubled cord in order to ease the threading process. The interior diameters of rochaille bead 140 vary slightly from bead to bead. For this application, bead 140 should be chosen such that it has a hole that is big enough to accommodate the doubled cord 110, but small enough to provide some resistance when slid up and down the doubled cord 110. Bead 150, if used, should share the same characteristics as bead 140.

After bead 140 (and bead 150 if used) have been threaded onto cord 110, the cut ends of cord 110 are then tied together approximately 0.5 inches from the ends using a water knot or overhand knot 160. After tying the cord ends together, bead 140 (and 150 if used) are slid down to the end having knot 160. At this point, the folded end of cord 110 is slipped through the front of hole 190. The knotted end of cord 110 is then brought over from the back and slipped through the loop made by the folded end of the cord, and then pulled until the loop is tight up against label portion 120 of tag 100. If used, bead 150 is then slid up tight against label portion 120.

Once this procedure has been completed, tag 100 may be secured to one of a practically infinite number of objects which are to be labeled. By way of example, tag 100 may be attached to a pair of swim goggles by looping cord 110 (in its doubled over form) around the swim goggle strap and using bead 140 to hold cord 110 tight. To attach tag 100 to a pair of swim goggles, bead 140 is slid up to tag 100. The swim goggle strap is placed over cord 110 (in its doubled over form). The label portion 120 of tag 100 is folded over the goggle strap and threaded between the doubled portions of cord 110. Label portion 120 is pulled, tightening the loop at cord 110 and bead 140 is slid down tight against the loop to provide an anchor to secure it.

As alluded to above, a practically infinite number of tagging applications may be satisfied with the identification tag 100 of the present invention. Solely by example and without limitation other applications for tagging include tags for ski equipment, lunch boxes, scuba and snorkel gear, cases for eyeglasses and eyeglasses themselves, cellular phones, “Gameboys” and other portable electronic devices, laptops and desktop computers, backpacks, cameras and camera cases, keychains, sporting goods, and various other objects that may otherwise get lost or misidentified.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

1. An identification tag comprising:
(a) a label portion having information contained thereon;
(b) a flexible cord attached to said label portion at one end and to an object to be labeled at another end;
(c) wherein said label portion is formed from heat shrinkable material and wherein at least one bead is located on said flexible cord for securing said flexible cord to said object to be labeled.

2. The identification tag of claim 1 wherein said heat shrinkable material is heat shrinkable plastic.

3. The identification tag of claim 2 wherein said heat shrinkable plastic and said flexible cord are waterproof.

4. The identification tag of claim 1 further comprising a second bead for securing said flexible cord to said label portion.

5. The identification tag of claim 1 wherein said object to be labeled is a pair of swim goggles.

6. The identification tag of claim 1 wherein said object to be labeled is a cellular telephone.

7. The identification tag of claim 1 wherein said label portion includes an identification portion and wherein said identification portion includes textual information.

8. The identification tag of claim 1 wherein said flexible cord is attached to said label portion by passing said flexible cord through a hole in said label portion and looping said flexible cord through itself.

9. The identification tag of claim 1 wherein said flexible cord is attached to said object to be identified by looping said flexible cord around said object to be identified or a portion thereof and looping said flexible cord through itself.

10. A method for manufacturing an identification tag comprising the steps of:
(a) outlining a label shape;
(b) creating textual information within said label shape;
(c) printing said label shape and said textual information on a sheet of heat shrinkable material;
(d) cutting said shape from said sheet of heat shrinkable material;
(e) punching a hole in said cut shape;
(f) heating said heat shrinkable material to shrink said heat shrinkable material; and
(g) passing a flexible cord through said hole and looping said flexible cord through itself to attach said flexible cord to said heat shrinkable material.

11. The method of claim 10 wherein said heat shrinkable material is heat shrinkable plastic.

12. The method of claim 10 further comprising the step of threading a bead onto said flexible cord, said bead being provided for securing said flexible cord to an object to be identified.

13. The method of claim 12 further comprising the step of threading a second bead onto said flexible cord, said second bead being provided for securing said flexible cord to said heat shrinkable material.

14. The method of claim 10 wherein said identification tag is attached to a pair of swim goggles.

15. The method of claim 10 wherein said identification tag is attached to a cellular telephone.

16. The method of claim 10 wherein said heat shrinkable material is waterproof.
